(19) United States
(12) Patent Application Publication
(10) Pub. No.: US 2024/0419846 A1
(43) Pub. Date: Dec. 19, 2024

(54) SYSTEMS, DEVICES, AND METHODS FOR DETECTING A POTENTIAL TAMPER CONDITION OF A SECURE DEVICE

(71) Applicant: VeriFone, Inc., Wilmington, DE (US)

(72) Inventors: Santhosh Gillella, Naperville, IL (US); John Barrowman, Knoxville, TN (US)

(73) Assignee: VeriFone, Inc., Wilmington, DE (US)

(21) Appl. No.: 18/705,108

(22) PCT Filed: Oct. 29, 2021
(86) PCT No.: PCT/US2021/072118

§ 371 Date: Apr. 26, 2024

(51) Int. Cl. G06F 21/74

(52) U.S. Cl. CPC G06F 21/74; G06F 2221/2111

(57) ABSTRACT

A secure device for detecting a potential breach during shipment that includes a transceiver module operable to generate an output signal according to one or more radio-frequency signals received by the transceiver module; and a controller configured to enter a secure shipping state, wherein the controller is configured to determine whether the output signal exceeds a predetermined threshold and to determine at least one identifier from the output signal; wherein the controller is further configured take a protective action if the output signal exceeds the predetermined threshold and the identifier does not match a predetermined identifier, wherein the controller is configured to exit the secure shipping state if the output signal exceeds the predetermined threshold and the identifier matches the predetermined identifier.

### BACKGROUND

Aspects and implementations of the present disclosure are generally directed to systems, devices, and methods for detecting a potential tamper condition of a secure device occurring during shipment.

Point-of-sale devices, such as pin-entry devices, are vulnerable to tampering during shipment. Attackers, if able to intercept the shipment, can place a device known as skimmer or a probe, in the point-of-sale device, which can read and transmit sensitive information, including credit and debit card numbers and pins to the attacker. Previous attempts to secure the point-of-sale device during shipment, have included, for example, the use of tamper evidence bags. But these are expensive and easily circumvented, since many tamper evident bags can be acquired by the attackers, who reseal the point-of-sale device in the tamper evident after breaching the point-of-sale device.

Accordingly, there is a need in the art for system, device, or method that can determine whether a shipping container has been breached in a manner that could allow for tampering of the point-of-sale device.

### SUMMARY

All examples and features mentioned below can be combined in any technically possible way.

According to an aspect, a secure device for detecting a potential breach during shipment, includes: a transceiver module operable to generate an output signal according to one or more radio-frequency signals received by the transceiver module; and a controller configured to enter a secure shipping state, wherein the controller is configured to determine whether the output signal exceeds a predetermined threshold and to determine at least one identifier from the output signal; wherein the controller is further configured take a protective action if the output signal exceeds the predetermined threshold and the identifier does not match a predetermined identifier, wherein the controller is configured to exit the secure shipping state if the output signal exceeds the predetermined threshold and the identifier matches the predetermined identifier.

In an example, the protective action comprises displaying a notification on a display.

In an example, the protective action comprises transmitting a message to at least one party.

In an example, the protective action comprises entering a secure state in which at least one capability of the secure device is suspended.

In an example, the at least one capability is the ability to process payments.

In an example, the at least one capability is the ability to receive encryption keys.

In an example, the secure state persists until the controller receives a predetermined set of credentials.

In an example, the predetermined identifier is a location.

In an example, the predetermined identifier is a network identification parameter.

In an example, the transceiver module includes an ultra-wide band antenna.

According to another aspect, a program method, being stored on a non-transitory storage media and executed by one or more processors, includes: entering a secure shipping state; receiving an output signal from a transceiver module, the output signal representing one or more radio-frequency signals received by the transceiver module, wherein the transceiver module receives the one more radio-frequency signals with an ultra-wide band antenna; determining whether the output signal exceeds a predetermined threshold, and performing one of: taking a protective action if the output signal exceeds the predetermined threshold and at least one predetermined identifier cannot be identified from the output signal, or exiting the secure shipping state if the output signal exceeds the predetermined threshold and the at least one predetermined identifier can be identified from the output signal.

In an example, the protective action comprises displaying a notification on a display.

In an example, the protective action comprises transmitting a message to at least one party.

In an example, the protective action comprises entering a secure state in which at least one capability of a secure device is suspended.

In an example, the at least one capability is the ability to process payments.

In an example, the at least one capability is the ability to receive encryption keys.

In an example, the secure state persists until the controller receives a predetermined set of credentials.

In an example, the predetermined identifier is a location.

In an example, the predetermined identifier is a network identification parameter.

According to another aspect, a secure device for detecting a potential breach during shipment includes: a transceiver module operable to generate an output signal according to one or more radio-frequency signals received by the transceiver module; and a controller configured to enter a secure shipping state, wherein, in the secure shipping state, the controller is configured to determine whether the output signal exceeds a predetermined threshold and to determine a location from the output signal, wherein the controller is further configured perform a protective action if the output signal exceeds the predetermined threshold and the location does not match a predetermined location, wherein the protective action comprises entering a secure state in which at least one capability of the secure device is suspended, wherein the controller is configured to exit the secure shipping state if the output signal exceeds the predetermined threshold and the location matches the predetermined location.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic illustration of the internal components of a secure device located within a shielded shipping container, according to an example.

FIG. 2A is a flow chart illustrating the steps of a method, according to an example.

FIG. 2B is a partial flow chart illustrating the steps of a method, according to an example.

FIG. 2C is a partial flow chart illustrating the steps of a method, according to an example.

FIG. 2D is a partial flow chart illustrating the steps of a method, according to an example.

FIG. 2E is a partial flow chart illustrating the steps of a method, according to an example.

FIG. 2F is a partial flow chart illustrating the steps of a method, according to an example.

### DETAILED DESCRIPTION

Various examples described in this disclosure relate to devices and methods for detecting when a potential tamper occurs during shipment.

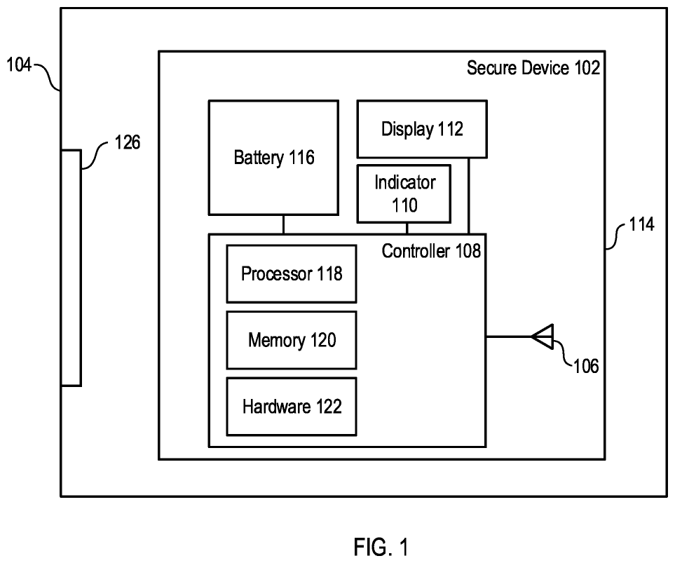

FIG. 1 depicts a block diagram of an example secure device 102 being shipped to an intended recipient of the secure device. The secure device 102, as shown in FIG. 1, is shipped in a shielded shipping container 104, which shields secure device 102 from any radiofrequency (RF) energy during shipment. At a high level, secure device 102 employs a transceiver module 106 to monitor the incident RF energy during shipment to detect whether shielded shipping container 104 has been opened in a manner that would permit tampering with secure device 102.

More particularly, as shown in FIG. 1, secure device 102 includes a transceiver module 106 in electrical communication with controller 108. Transceiver module 106 produces an output signal based on incident RF energy. Controller 108 is configured to monitor the output signal (which itself can be amplified and processed) of transceiver module 106. Because RF energy is pervasive in nearly any modern environment—due to cellular networks, WiFi signals, Bluetooth signals, radio signals, satellite signals, etc.—when the shielded container 104 is opened, ambient RF energy will inevitably flood the internal compartment. RF transceiver module 106 is tuned to detect at least one type of common RF signal (i.e., that can be expected to exist within the shipping route). If the output signal exceeds a predetermined threshold, controller 108 can perform a destination check to determine whether secure device 102 has reached its intended destination. In various examples, determining whether secure device 102 has reached its intended destination can comprise determining a predetermined identifier from a standard-compliant carrier within the RF energy. It is, however, contemplated that other methods of determining whether secure device 102 has reached its intended destination can be used, such as beginning a timer, during which a predetermined action (e.g., receiving a password or keys) must occur, or comparing the date/time that RF energy is detected against an expected date/time that the shielded shipping container 104 was to be received by the intended recipient. These and other examples of destination checks will be described in more detail below.

If controller 108 determines that secure device 102 has not reached its intended destination—e.g., as determined by the absence of the predetermined identifier or the occurrence of a predetermined action—controller 102 can take at least one protective action, which is any action that will alert a party of a potential breach. In various examples, the alert can take the form of a message sent to the party—such as an intended recipient or to a manufacturer or vendor—or can take the form of an illuminated indicator 110 (e.g., an LED) or a notification on a display 112 on a housing 114 of secure device 102. Alternatively, the alert can take the form of entering a secure state, in which the configuration of secure device 102 for use (e.g., key injection) or the performance of sensitive actions (e.g., processing of any payments) are suspended, at least until some action is taken, such as the input of a unique password, to exit the state. The alert is generally intended to prompt the intended recipient to have the device disassembled and inspected for tampering.

If, however, controller 108 determines that it has reached its intended destination, controller 108 can exit the secure shipping state, such that the device is in an operational state where it can be used or configured for use.

In various examples, secure device 102 can be any device for which it is desirable to prevent tampering during shipment. In one example, secure device 102 can be a payment processing device such as a point-of-sale (POS) device. The use of the term “POS device” is meant to be an exemplary and non-limiting term for devices that can accept and process payments. Examples POS devices include pin-entry devices, card payment terminals, electronic cash registers, automated teller machines (ATMs), card readers/controllers, and the like, as well as unattended POS devices, such as petrol kiosks. Such POS devices are typically configured to receive payment information from a user (e.g., via a magnetic stripe, a chip, or a wireless protocol such as NFC) and to process the payment information to approve the transaction by communicating with one or more cloud/backend servers, such as a payment processing network (e.g., VHQ). An example of a POS device contemplated by this disclosure is a Carbon Mobile 5, sold by Verifone. A POS device is, however, only one type of secure device the shipment of which could be secured; in alternative examples, the secure device can be other types of devices, such as a security printer, used for printing sensitive documents such as prescriptions, or devices used for configuring POS devices, such as key loading devices or hardware security modules, which themselves possess sensitive data.

Shielded shipping container 104 can be any container that is lined with or includes a conductor arranged in a manner that shields the contents of the container from RF energy. An example of such a shielded container is the Leader Tech Inc. 44-CBSA-0.5×1.0×0.4 shielded container, although other suitable shielded containers are contemplated.

The process of determining whether the RF energy exceeds a threshold can be performed, for example, as part of the “energy detect” phase during a clear channel assessment prior to carrier detection. If the energy detect threshold is met, it can be determined that the shielded shipping container has been opened. At this point, a destination check can be performed to determine whether secure device 102 has reached its intended destination. In one example of a destination check, controller 108 can begin carrier detection to identify any carriers (e.g., the carrier frequency of an ultra-wide band, Wi-Fi, Bluetooth, cellular, or GPS signal). If a carrier frequency is detected, the signal can be checked for a compliant standard, such as the 802.15.4 standard (i.e., the UWB standard), the 802.11 standard (WiFi standard), or other suitable standard. In this example, if a compliant standard is detected, the RF signal is checked for predetermined identifiers to determine whether the secure device has reached its intended destination. Examples of such predetermined identifiers can include location data or network identification parameters of the wireless network at the intended recipient. The network identification parameter can be a MAC address, although any other suitable form of unique identifier for the network can be used. If the predetermined location identification parameters are not identified (which can include not detecting a standard-compliant signal in the first instance), the one or more protective actions can be taken, as outlined in more detail below. If, however, the predetermined location identification parameters are detected, it can be assured that secure device 102 has reached its intended destination and can exit the secure shipping state and enter an operational state in which the device can be used or configured for use.

Of the above listed predetermined identifiers, the location (which can be relative location, e.g., a location determined with respect to one or more transmitting or receiving antennas, or an absolute location, e.g., a set of coordinates relative to a known point on the earth) is particularly useful for determining whether secure device 102 has reached its intended destination. It is, for example, conceivable that an unauthorized user could potentially intercept the shipping container and open it within range of the wireless network at the intended shipping location. Accordingly, location detection with enough accuracy to discriminate against an unauthorized user that opens the package within range of the network, but not within a predetermined location, is useful for protecting against this kind of unauthorized access. It is recognized the UWB, which offers location detection with accuracy up to 2 cm, is a particularly useful option to determine whether secure device 102 is being opened in the proper facility. For example, if UWB anchors are deployed within the intended destination, the location of the secure device 102 can be determined with a high degree of accuracy. If controller 108 determines that it is not within a particular range or location with respect to the anchors (e.g., a particular location within a receiving facility), it can perform the protective action, as tampering is likely. It should, however, be understood that UWB is only provided as an example, and other methods of determining location, such as using WiFi, cellular signal, or GPS, as known in the art, are contemplated.

Other methods can be used to determine whether secure device 102 has reached its intended destination (i.e., as a destination check). The simplest of these is likely to store an expected date/time of arrival (this can be in the form of a clock implemented by controller 108) and compare it to the time at which the RF energy was detected. If the RF energy was detected at a time that is earlier than the stored time, it can be assumed that the RF energy was detected because of someone intercepting the package before it was delivered to its intended recipient and the protective action can be performed. Alternatively, the RF energy exceeding the predetermined threshold can act to trigger a timer that represents that length of time that a predetermined password or other predetermined action must be received/performed. If the time for receiving the predetermined credentials or action elapses, controller 108 will initiate the protective action. Because a breach will likely be followed by repackaging the device within the secure container, the timer can be set for a length of time in which the intended recipient could easily enter a password or otherwise perform a predetermined action but would preclude repackaging and opening the secure device 102 a second time. In yet another example, detecting RF energy that is greater than the predetermined threshold can trigger a second monitoring window, during which, if the RF energy is detected as dropping below the predetermined threshold, it can be assumed that secure device 102 has been repackaged in the secure shipping container and the protective action can be taken. Various combinations of the above-described destination checks, and other potential destination checks, are contemplated.

As described above, a protective action can be taken if the destination check fails. The protective action is any alert that will notify a party—e.g., the intended recipient, a manufacturer, or other entity/person—of a potential breach, so that the secure device can be checked for devices such as skimmers before being used. Such an alert can take the form of a notification displayed on display 112, or by illuminating an indicator light 110. Alternatively, or additionally, the alert can take the form of a message sent to the party over a wired or wireless network, such as the internet (e.g., via a cellular connection) or a payment processing network. The message can include information regarding the potential breach, such as the location of the secure device (either a relative location or an absolute location) when the breach occurred, any detected signals, or other gathered information during the potential breach. Alternative or additionally, the alert can take the form of a protective state, in which the configuration of the device for use (e.g., key injection) or the performance of sensitive actions (e.g., processing of any payments) are suspended, at least until some action is taken, such as the input of a unique password or other credentials, to exit the state. Generally, the use of system-state passwords to remove secure device 102 from the secure state are ill-advised since the system state passwords of secure device 102 are often set to default values prior to configuration.

Transceiver module 106 includes an antenna to receive RF energy as typically exists within a modernized inhabited environment. One type of suitable antenna is an ultra-wide band antenna, which is typically tuned to detect RF energy from approximately 3-10 GHz. An added advantage to using a UWB antenna is the relatively low power consumption required to operate such an antenna. For example, a typical coin-cell battery may power the antenna for the required period of operation without any need to draw any power from the POS device. In other examples, the antenna can be tuned to 2.4 GHz with its highest efficiency in the band of 2.4 Ghz to 2.5 Ghz. According to various examples, the antenna can be tuned to other frequencies to accommodate detection of various RF transmission protocols. Although only one antenna is represented in FIG. 1, in alternative examples of transceiver module 106, multiple antennas can be employed to detect RF energy. (Further, the same or a different antenna can be used for wirelessly communicating with a remote server for the purposes of processing payments, or performing the protective action or other functions as is useful for a secure device or for performing the functions described in this disclosure.) Transceiver module 106 can also include components for decoding the RF energy received at the antenna. Examples of such components can include a low-noise amplifier, a down converter, and a demodulator, although any suitable method for decoding the RF energy can be used. Additionally, transceiver module 106 can include other components for processing the received RF energy, such as filters, A/D converters, etc. In certain examples, transceiver 106 can also encode and transmit RF energy, although it is contemplated that, in other examples, transceiver module 106 can be only capable of receiving and decoding.

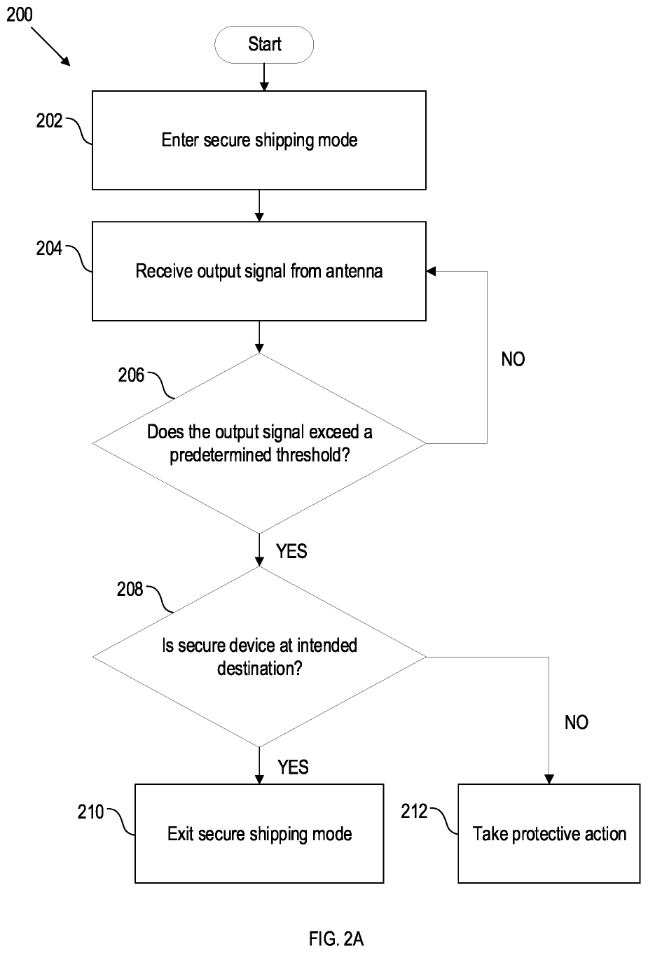

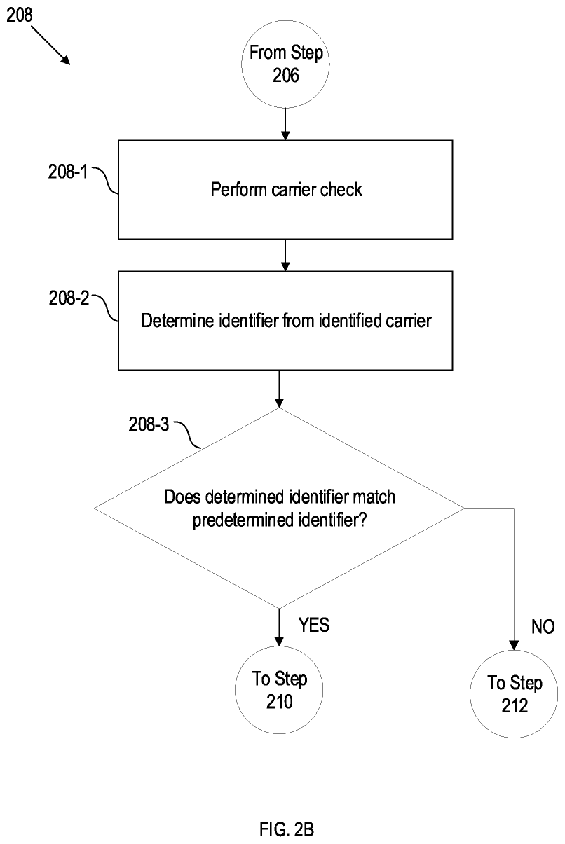

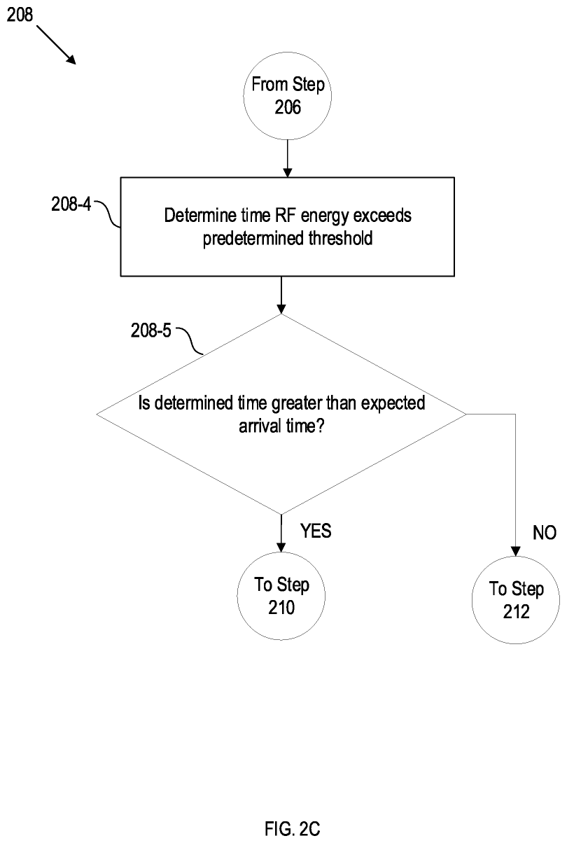

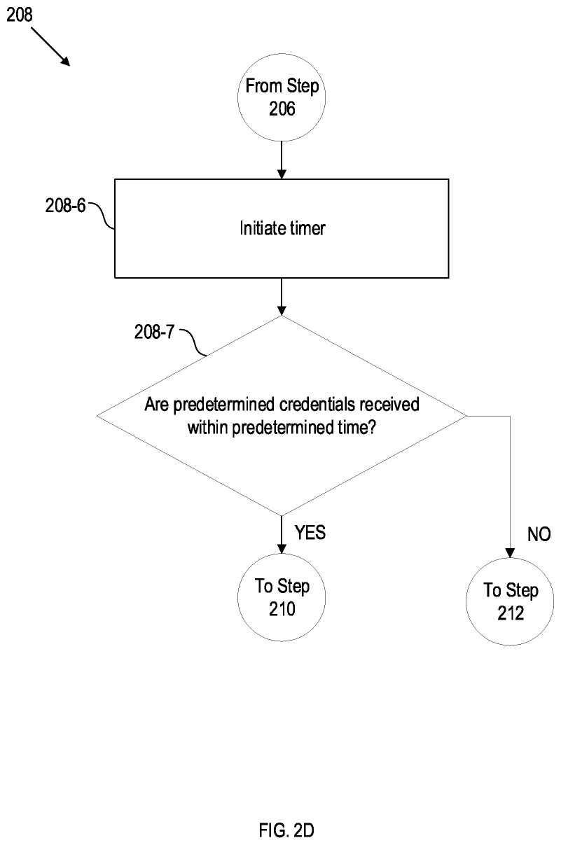

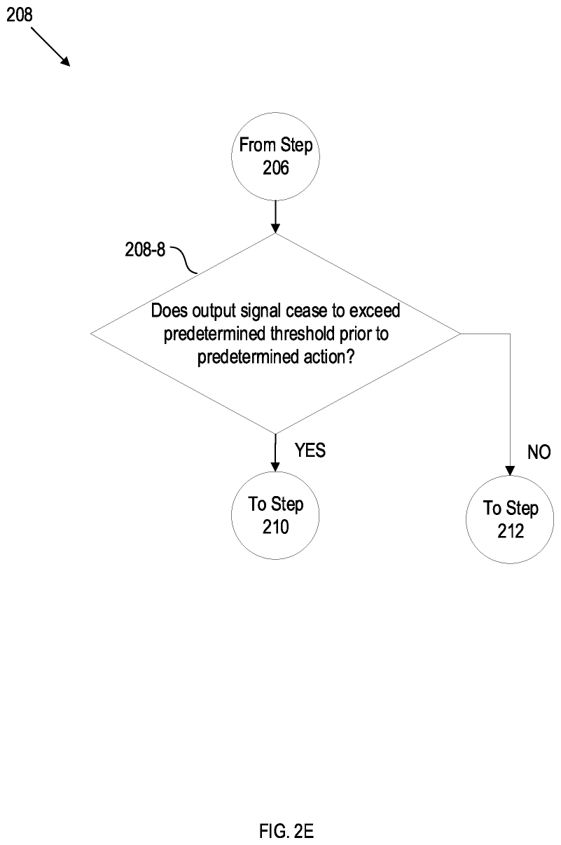

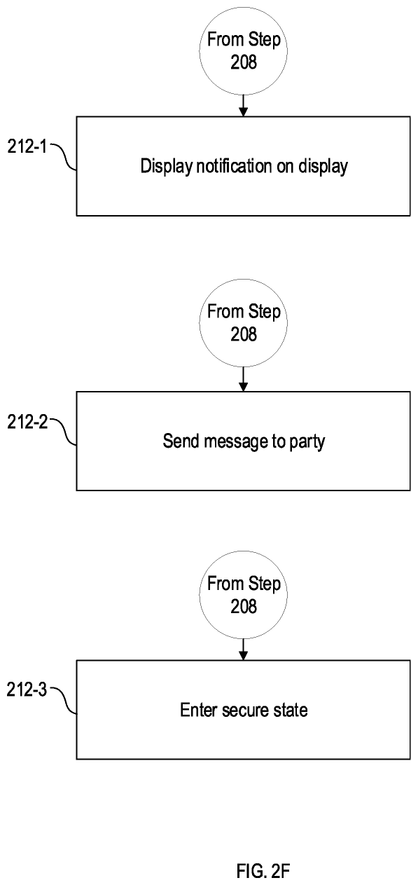

In various examples, controller 108 can be one or more processors 118, and any associated hardware 122, configured to execute at least one step (e.g., the steps described in connection with the method of FIG. 2) stored in a non-transitory storage medium, such as memory 120, to perform the various function described in this disclosure. For example, controller 108 can be a microprocessor or microcontroller executing steps stored in memory 120 (either as firmware or software). In the example of the POS device, the one or more processor can be the processor(s) used to process payments received from customers; in alternative examples, however the controller can be implemented by one or more processors separate from, or in combination with, the processor(s) used to process payments. In addition, some or all of the functions implemented by controller can be performed by exclusively by hardware. For example, it is contemplated that comparing the output signal to a threshold can be performed by circuitry apart from any processor, as comparators are known in the art. Similarly, certain destination checks and certain protective actions, such as illuminating an indicator light can be performed by hardware apart from any processor. Accordingly, controller 108 can be implemented by one or more processors with any associated hardware or by hardware apart from any processors.

Further, as shown in FIG. 1, secure device 102 can include a battery 116 to power controller 108 during shipment. Many transceiver modules, including UWB transceiver modules, require comparatively small amounts of power to operate. In fact, a small battery, such as a coin cell battery, can often be sufficient to perform the steps of method 200 and functions described in this disclosure.

Although the components for detecting the potential breach, including controller 108, battery 116, display 112, and indicator 110, are shown contained within housing 114; in an alternative example, these can be located outside of housing 114 of secure device 102, e.g., within a separate, independent housing. Indeed, the components for determining whether secure shipping container 104 has been breached can be placed within a standalone device separate from secure device 102.

It is further contemplated that an attacker could use a shielded room or other shielded enclosure to conceal a breach of shielded shipping container 104. In other words, if the environment that the shielded shipping container is opened in is itself shielded, the breach could be concealed as the ambient RF energy would never rise to a detectable level. To address this, shielded shipping container 104 can be made to emit RF energy when opened, e.g., with a transmitter module 126 disposed within shielded shipping container. The RF energy emitted by the shielded shipping container can be detected by transceiver module 106 and controller 108, initiating the destination check. If only the RF energy from the transceiver located within the shipping container 104 is detected, the destination check will fail, and the protective action taken. In one example, the transmitter module 126 can be a UWB tag, e.g., powered by a coin cell battery, placed in an on state when shielded shipping container 104 is opened. In certain examples, transmitter module 126 can include a modulator, up converter, and power amplifier. However, because it is not strictly necessary to encode information within the RF energy, transmitter module 126 can take a variety forms, as such devices are known in the art. Indeed, transmitter module 126 can be any suitable device that includes a transmit antenna and is configured to emit detectable RF energy.

FIGS. 2A-2F depict a method 200 for detecting a potential breach of a shielded shipping container. Method 200 can be performed by a controller, such as controller 108, which typically includes one or more processors configured to execute at least one step of method 200 stored in a non-transitory storage medium. However, as described in connection with controller 108, some or all of steps can be implemented by hardware apart from a processor. While the steps of method 200 can be performed by a controller disposed within a housing of a secure device (e.g., a POS device or a security printer), in alternative examples, controller can be implemented in a standalone device that does not have additional functions or has functions that are not typically considered sensitive or secure.

At step 202, controller enters a secure shipping state (in which steps 204-208 are performed). In this state, the output signal from and antenna is monitored—while the secure device is shipped in a shielded shipping container—and used to determine whether to implement a protective action or to exit the secure shipping state. In general, the secure shipping state can be initiated by the shipping party (e.g., a manufacturer) by entering a command or otherwise setting the state of the secure device. Because there is almost certainly some time required to place the secure device within the shielded shipping container after setting the controller into the secure shipping state, there can be some delay implemented between step 202 and later steps.

At step 204, the output signal from the transceiver module is received by the controller. It should be understood that the output signal, as received by the controller, can be decoded (e.g., amplified, downconverted, and demodulated) by the transceiver module before being received by the controller so that the output signal is in a form that can be interpreted by the controller.

Step 206 represents a decision block that determines whether the output signal of the transceiver module exceeds a predetermined threshold. This is to determine whether the ambient RF energy has entered the shielded shipping container in a manner that would likely indicate a breach, and which could allow for tampering (e.g., the placement of a skimmer) of the secure device. The predetermined threshold can be set at any level to detect the presence of RF energy with acceptable confidence. In one example, the predetermined threshold can be set at a threshold at which any detected energy would be sufficient to exceed the threshold. (In other words, the threshold is exceeded once the RF energy is at all detectable.) In an alternative example, step 206 can be implemented as part of an “energy detect,” as is normally implemented during a clear channel assessment prior to carrier detection. If the output signal exceeds the predetermined threshold, the method can proceed to the destination check of step 208. If the output signal does not exceed the predetermined threshold, the method can return to step 204, receiving the output signal from the transceiver module.

In an example, the shielded shipping container can include an RF transmitter module that emits RF energy when the shielded shipping container is opened. This is to prevent an attacker from thwarting efforts to detect ambient RF energy by opening the shielded shipping container in a shielded room or other shielded enclosure. In this example, when the shielded shipping container is opened, the transceiver module will detect, at a minimum, the RF energy emitted by the transmitter module, and will begin the destination check of step 208.

Step 208 is a decision block that determines whether the secure device is at an intended destination (i.e., a destination check). This step can be performed in any number of ways, including by determining a predetermined identifier (e.g., a location or a network identification parameter) from the transceiver module output signal, or by comparing the time that the RF energy exceeded the predetermined threshold to an expected time the package was to be received, or by waiting a predetermined period of time to receive a password or other predetermined credential, or by continuing to monitor the output signal of transceiver module to determine if it falls below the predetermined threshold (indicating that it is again placed within the shielded shipping container). These methods will be described in more detail in combination with FIGS. 2B-2F. It is, however, contemplated that other ways of determining whether the secure device has reached its intended destination can be used. If the destination check passes the method can exit the secure shipping state at step 210 and enter an operational state. If, however, the destination check fails the controller can perform a protective action at step 212.

Turning to FIG. 2B, there is shown one example of a destination check (i.e., step 208), in which the controller determines whether one or more predetermined identifiers are present within the output signal. At step 208-1, the controller performs a carrier detection to identify any carriers (e.g., the carrier frequency of an ultra-wide band, Wi-Fi, Bluetooth, cellular, or GPS signal). If a carrier frequency is detected, the signal can be checked for a compliant standard, such as the 802.15.4 standard (i.e., the UWB standard), the 802.11 standard (WiFi standard), or other suitable standard.

At step 208-2, the RF signal is checked for predetermined identifiers to determine whether the secure device has reached its intended destination. Examples of such predetermined identifiers can include location data or network identification parameters of the wireless network at the intended recipient. The network identification parameter can be a MAC address, although any other suitable form of unique identifier for the network can be used. As described above, the location (which can be relative location e.g., a location determined with respect to one or more transmitting or receiving transceiver modules, or an absolute location, e.g., a set of coordinates relative to a known point on the earth) is particularly useful for determining whether secure device 102 has reached its intended destination. In an example, the location can be determined as longitude and latitude determined relative UWB anchors positioned at the intended destination. In alternative examples, the location can be determined according by a WiFi network, by a cellular network, by GPS, or by any other suitable way for determining location. The predetermined identifiers are selected to be uniquely tied to the intended destination, such that, if the package is opened in the wrong location, the identifiers will not match the predetermined identifiers.

Step 208-3 is a decision block that represents the comparison of the identifiers determined at step 208-2 (e.g., the location or the network identification parameter) to the predetermined identifier. If the identifiers match the predetermined identifiers, then the method proceeds to step 210; however, if the identifiers do not match the predetermined identifiers, then the method proceeds to step 212.

For the purposes of this disclosure, the absence of determinable identifiers (e.g., because the carrier check did find a known carrier within the RF energy) is considered an identifier that does not match the predetermined identifier. Indeed, it is conceivable that a potential attacker could swamp the secure device with RF energy (alternatively referred to as “jamming” the device), such that the controller fails to detect the carrier or any identifier within a carrier. In this instance, however, failing to detect the carrier or an identifier within the carrier is considered the equivalent of comparing a null identifier to the predetermined identifier (since no identifier can be recovered from the RF energy), which results in the controller taking the protective action in step 212 in the same manner as an incorrect identifier being recovered from the carrier. To further account for this scenario, a clock can be started when the RF energy exceeds the threshold during which the predetermined identifier must be recovered from the RF energy to prevent the protective action of step 212. If an identifier matching the predetermined identifier is not found during a predetermined period of time, it can be assumed a jamming action is occurring, or that there is no otherwise no identifier to be discovered within the RF energy, and the method can progress to step 212.

In another example, as shown in FIG. 2C, the destination check of step 208 can comprise step 208-4, in which the time that RF energy exceeds the predetermined threshold is determined. This can be a relative time, e.g., a time that is determined with respect to a clock initiated when the controller enters the secure shipping state, or a time that is determined with respect to some external timekeeping standard. At step 208-5 the time that the RF energy exceeds the predetermined threshold is compared to an expected arrival time. The expected arrival time can be the time that the shielded shipping container is expected to be received by the intended recipient, accounting for shipping and/or transportation time.

In another example, shown in FIG. 2D, the destination check of step 208 can comprise step 206-6, in which a timer is initiated following the detection of the RF energy greater than the predetermined threshold. The controller then looks, at decision block 208-7, for a password or other credentials to be entered before the expiration of a predetermined time (i.e., with respect to the timer initiated in step 208-6). If the predetermined credentials are received before the predetermined time elapses, the method proceeds to step 210. However, if the predetermined time elapses without receiving the predetermined credentials (either entered by the intended recipient or wirelessly from a manufacturer or vendor) the method proceeds to step 212. Generally, the predetermined time is set to a length that would permit the credentials to be entered but would prohibit or make difficult the repackaging of the secure device within the secure container and delivering it to the intended recipient.

In yet another example, shown in FIG. 2E, the destination check of step 208 can comprise step 208-8, which is a decision block that determines whether the RF energy ceases to exceed the predetermined threshold before a predetermined action. In various examples, the predetermined action can be an attempt to configure of the device itself (e.g., key injection) or the receipt of predetermined credentials, such as a password. If the output signal does not cease to exceed the predetermined threshold and the predetermined action is performed, the method proceeds to step 210. If, however, the output signal ceases to exceed the predetermined threshold, it can be determined that the secure device was likely repackaged in the secure container and the method can proceed to step 212.

At step 210, as described above, the controller can exit the secure state. This generally permits the device to be used or configured for use, which can include various configuration steps such as key injection (e.g., if the secure device is POS device) or the entering of credentials. Step 210 can also include the step of sending a confirmation to a manufacturer or supplier that the destination check has passed.

At step 212, if the destination check has failed, the protective action is performed. The protective action is any alert that will notify a party—e.g., the intended recipient, a manufacturer, or other entity/person—of a potential breach, so that the secure device can be checked for devices, such as skimmers, or otherwise confirmed to be in proper working order. FIG. 2F depicts three alternative examples of protective actions that can be taken. For example, as shown in step 212-1, such an alert can take the form of a notification displayed on a display. In a variation of this example, the alert can take the form of illuminating an indicator light, such as an LED. Alternatively, as shown in step 212-2, the alert can take the form of a message sent to the party over a wired or wireless network, such as the internet (e.g., via a cellular connection) or a payment processing network. The message can include information regarding the potential breach, such as the location of the secure device (either a relative location or an absolute location) when the breach occurred, any detected signals, or other gathered information during the potential breach. Alternative or additionally, as shown in step 212-3, the alert can take the form of a protective state, in which the configuration of the device for use (e.g., key injection) or the performance of sensitive actions (e.g., processing of any payments) are suspended, at least until some action is taken, such as the input of a unique password or other credentials, to exit the state. Secure device 102 can be remain in the secure state until the unique password is locally input or remotely input, e.g., over a wireless network.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A secure device for detecting a potential breach during shipment, comprising:
a transceiver module operable to generate an output signal according to one or more radio-frequency signals received by the transceiver module; and
a controller configured to enter a secure shipping state, wherein the controller is configured to determine whether the output signal exceeds a predetermined threshold and to determine at least one identifier from the output signal;
wherein the controller is further configured take a protective action if the output signal exceeds the predetermined threshold and the identifier does not match a predetermined identifier,
wherein the controller is configured to exit the secure shipping state if the output signal exceeds the predetermined threshold and the identifier matches the predetermined identifier.

2. The secure device of claim 1, wherein the protective action comprises displaying a notification on a display.

3. The secure device of claim 1, wherein the protective action comprises transmitting a message to at least one party.

4. The secure device of claim 1, wherein the protective action comprises entering a secure state in which at least one capability of the secure device is suspended.

5. The secure device of claim 4, wherein the at least one capability is the ability to process payments.

6. The secure device of claim 4, wherein the at least one capability is the ability to receive encryption keys.

7. The secure device of claim 4, wherein the secure state persists until the controller receives a predetermined set of credentials.

8. The secure device of claim 1, wherein the predetermined identifier is a location.

9. The secure device of claim 1, wherein the predetermined identifier is a network identification parameter.

10. The secure device of claim 1, wherein the transceiver module includes an ultra-wide band antenna.

11. A program method, being stored on a non-transitory storage media and executed by one or more processors, the program method comprising:
entering a secure shipping state;
receiving an output signal from a transceiver module, the output signal representing one or more radio-frequency signals received by the transceiver module, wherein the transceiver module receives the one more radio-frequency signals with an ultra-wide band antenna;
determining whether the output signal exceeds a predetermined threshold, and performing one of:
taking a protective action if the output signal exceeds the predetermined threshold and at least one predetermined identifier cannot be identified from the output signal, or
exiting the secure shipping state if the output signal exceeds the predetermined threshold and the at least one predetermined identifier can be identified from the output signal.

12. The program method of claim 11, wherein the protective action comprises displaying a notification on a display.

13. The program method of claim 11, wherein the protective action comprises transmitting a message to at least one party.

14. The program method of claim 11, wherein the protective action comprises entering a secure state in which at least one capability of a secure device is suspended.

15. The program method of claim 14, wherein the at least one capability is the ability to process payments.

16. The program method of claim 14, wherein the at least one capability is the ability to receive encryption keys.

17. The program method of claim 14, wherein the secure state persists until the controller receives a predetermined set of credentials.

18. The program method of claim 11, wherein the predetermined identifier is a location.

19. The program method of claim 11, wherein the predetermined identifier is a network identification parameter.

20. A secure device for detecting a potential breach during shipment, comprising:
a transceiver module operable to generate an output signal according to one or more radio-frequency signals received by the transceiver module; and
a controller configured to enter a secure shipping state, wherein, in the secure shipping state, the controller is configured to determine whether the output signal exceeds a predetermined threshold and to determine a location from the output signal,
wherein the controller is further configured perform a protective action if the output signal exceeds the predetermined threshold and the location does not match a predetermined location, wherein the protective action comprises entering a secure state in which at least one capability of the secure device is suspended,
wherein the controller is configured to exit the secure shipping state if the output signal exceeds the predetermined threshold and the location matches the predetermined location.
